(19) United States
(12) Patent Application Publication
(10) Pub. No.: US 2025/0357517 A1
(43) Pub. Date: Nov. 20, 2025

(54) IONOMER, FUEL CELL, AND METHOD OF PRODUCING IONOMER

(71) Applicant: TOYOTA JIDOSHA KABUSHIKI KAISHA, Toyota-shi (JP)

(72) Inventor: Keiichi OKUBO, Suson-shi (JP)

(73) Assignee: TOYOTA JIDOSHA KABUSHIKI KAISHA, Toyota-shi (JP)

(21) Appl. No.: 19/016,375

(22) Filed: Jan. 10, 2025

(30) Foreign Application Priority Data
May 17, 2024 (JP) 2024-080987

(51) Int. Cl. H01M 8/1004; H01M 8/10; H01M 8/1039

(52) U.S. Cl. CPC H01M 8/1004; H01M 8/1039; H01M 2008/1095

(57) ABSTRACT

The ionomer has an acidic functional group, a fluorine-containing cyclic group, and a modifying layer that modifies the acidic functional group. In the ionomer, the fluorine-containing cyclic group contains a 3 to 16 ring member atoms, and the modifying layer contains a nitrogen-containing cyclic organic compound or a polymer thereof or a cation thereof.

### CROSS-REFERENCE TO RELATED APPLICATION

This application claims priority to Japanese Patent Application No. 2024-080987 filed on May 17, 2024, incorporated herein by reference in its entirety.

### BACKGROUND

### 1. Technical Field

The present disclosure relates to an ionomer, a fuel cell, and a method of producing the ionomer.

### 2. Description of Related Art

Fuel cells cause hydrogen and oxygen to electrochemically react to thereby obtain electrical power. In principle, only water is produced as a product of power generation achieved by the fuel cells. Therefore, the fuel cells have attracted attention as clean power generation systems with little burden on the global environment. A fuel cell is configured of, as a basic unit, a membrane electrode assembly (hereinafter, also referred to as an “MEA”) in which electrode catalyst layers are disposed on both surfaces of an electrolyte membrane and gas-diffusion layers are further disposed on the outer side of the electrode catalyst layers. During operation of the fuel cell, an electromotive force is obtained by supplying fuel gas containing hydrogen to the electrode catalyst layer on the anode (fuel electrode) side and an oxidizing gas containing oxygen to the electrode catalyst layer on the cathode (air electrode) side. An oxidation reaction of hydrogen proceeds at the anode, a reduction reaction of oxygen proceeds at the cathode, and the electromotive force is supplied to an external circuit. Therefore, an oxygen reduction catalyst having an oxygen reducing ability is used for the electrode catalyst layer of the cathode. A polymer electrolyte having an ion exchange group (hereinafter, also referred to as an “ionomer”) is typically used for a binder of the electrode catalyst layers and the electrolyte membrane.

For example, Japanese Unexamined Patent Application Publication No. 2021-161154 (JP 2021-161154 A) describes an ionomer containing an acidic group-containing polymer and a basic group-containing metal complex.

### SUMMARY

As described above, various ionomers that can be used for electrode catalyst layers in fuel cells have been developed. In an electrode catalyst layers of a fuel cell, particularly, in an electrode catalyst layer of a cathode, it is necessary to smoothly supply protons and oxygen to an electrode catalyst. A typical ionomer has an acidic ion exchange group and can contribute to proton transport while the ionomer may inhibit oxygen transport. In regard to such a problem, JP 2021-161154 A, for example, describes that an ionomer containing an acidic group-containing polymer and a basic group-containing metal complex exhibits high oxygen solubility even under an acidic condition. Also, JP 2021-161154 A also describes that an ionomer containing an acidic group-containing polymer exhibits high oxygen permeability by the acidic group-containing polymer having an aliphatic ether ring structure that is a fluorine-containing cyclic group. However, there is room for improvement in binder performance and surface active performance of the electrode catalyst in such an ionomer in the related art.

Therefore, an object of the present disclosure is to provide an ionomer having high binder performance and surface active performance.

The present inventor has studied various means for solving the above problem. The present inventor has used a modifying layer containing a nitrogen-containing cyclic organic compound or a polymer thereof or a cation thereof as a modifying layer that modifies an acidic functional group of an ionomer having a fluorine-containing cyclic group. The present inventor has thus found that binder performance and surface active performance of the ionomer are improved. The present inventor has completed the present disclosure based on the above findings.

In other words, the present disclosure encompasses the following aspects and embodiments.

### First Embodiment

An ionomer includes:
an acidic functional group; a fluorine-containing cyclic group; and a modifying layer that modifies the acidic functional group. In the ionomer, the fluorine-containing cyclic group contains a 3 to 16 ring member atoms, and the modifying layer contains a nitrogen-containing cyclic organic compound, a polymer of the nitrogen-containing cyclic organic compound, or a cation of the nitrogen-containing cyclic organic compound or the polymer.

### Second Embodiment

In the ionomer of the first embodiment,
the fluorine-containing cyclic group is 1,3-dioxolane-4,5-diyl substituted with one or more perfluoroalkyls.

### Third Embodiment

In the ionomer of the first or second embodiment,
the modifying layer contains 1,3,5-triazine, ammelide, or melamine.

### Fourth Embodiment

A fuel cell includes at least:
an electrode catalyst layer of a cathode containing an electrochemical oxygen reduction catalyst and the ionomer according to any one of the first to third embodiments; an electrode catalyst layer of an anode; and an electrolyte membrane disposed between the electrode catalyst layer of the cathode and the electrode catalyst layer of the anode.

### Fifth Embodiment

A method of producing the ionomer according to any one of the first to third embodiments includes:
mixing an ionomer material having an acidic functional group and a fluorine-containing cyclic group with a modifying agent containing a nitrogen-containing cyclic organic compound, a polymer of the nitrogen-containing cyclic organic compound, or a cation of the nitrogen-containing cyclic organic compound or the polymer, and modifying the acidic functional group.

According to the present disclosure, it is possible to provide an ionomer having high binder performance and surface active performance.

### DETAILED DESCRIPTION OF EMBODIMENTS

Hereinafter, preferred embodiments of the present disclosure will be described in detail.

### 1: Ionomer

One aspect of the disclosure pertains to ionomers. The ionomer of this embodiment has an acidic functional group, a fluorine-containing cyclic group, and a modifying layer that modifies the acidic functional group.

Examples of the polymer constituting the ionomer of the present embodiment include polymers containing perfluorocarbon, polyether ether ketone, polybenzimidazole, and the like as main components. The polymer constituting the ionomer of the present embodiment is preferably a perfluorocarbon. The ionomer of the present embodiment can exhibit high proton conductivity by being composed of the polymer exemplified above.

In the ionomer of the present embodiment, examples of the acidic functional group include a sulfonic acid group and a phosphoric acid group. The acidic functional group is preferably a sulfonic acid group. By having the acidic functional group exemplified above, the ionomer of the present embodiment can exhibit high proton conductivity.

In each embodiment of the present disclosure, the fluorine-containing cyclic group means a monocyclic or polycyclic cyclic group having one or more fluorine atoms as a substituent of a ring-binding group and/or a ring-binding group. In the ionomers of this embodiment, the fluorine-containing cyclic group typically contains in the range of 3 to 16 ring member atoms. The number of ring member atoms of the fluorine-containing cyclic group is preferably in the range of 3 to 6. The cyclic group constituting the fluorine-containing cyclic group may contain, as a ring member atom, one or more hetero atoms such as an oxygen atom, a nitrogen atom or a sulfur atom in addition to a carbon atom. Examples of the cyclic group constituting the fluorine-containing cyclic group include monovalent or polyvalent groups derived from cyclopropane, cyclobutane, cyclopentane, cyclohexane, oxirane, furan, tetrahydrofuran, 1,3-dioxolane, 1,4-dioxane or propanedisulfonimide. The cyclic group exemplified above may have one or more fluorine atoms as a ring-binding group and/or a substituent of the ring-binding group. Examples of the substituent having one or more fluorine atoms include linear or branched perfluoroalkyl, perfluoroalkylene and perfluoroalkoxy having a carbon number ranging from 1 to 10. The substituents exemplified above may be interposed by one or more hetero atoms such as an oxygen atom, a nitrogen atom, or a sulfur atom. When the fluorine-containing cyclic group has a dissociable group, the fluorine-containing cyclic group may be in the form of a free acid or a free base, or may be in the form of a salt with any counterion. In each aspect of the disclosure, the fluorine-containing cyclic group is preferably 1,3-dioxolane-4,5-diyl substituted with one or more perfluoroalkyls. By having the fluorine-containing cyclic group exemplified above, the ionomer of the present embodiment can exhibit high binder performance and surface-active performance.

In the ionomer of this embodiment, the structures of the constituent macromolecules, acidic functional groups and fluorine-containing cyclic groups can be determined, for example, by analyzing the ionomer of this embodiment in the following manner. For example, elemental analyses, various chromatographic methods, ultraviolet-visible spectroscopy (UV-Vis), infrared spectroscopy (IR) or nuclear magnetic resonance (NMR).

In the ionomer of this embodiment, the modifying layer comprises a nitrogen-containing cyclic organic compound or a polymer thereof or a cation thereof. The component may interact with the polymer constituting the acidic functional group and/or the ionomer. For example, the component usually forms a complex, in particular an ionic bond, with the acidic functional group modified with the modifying layer. Prior art ionomers that do not have a modifying layer usually have a high crystallinity of the polymer constituting the ionomer, and therefore have a low oxygen transport property inside the ionomer. In addition, in the ionomer of the related art, since the polymer constituting the ionomer has high adsorption property to the electrode catalyst, the oxygen transport property at the interface between the ionomer and the electrode catalyst is low. Furthermore, the ionomer of the prior art (for example, JP 2021-161154 A) has an acidic group-containing polymer having an aliphatic ether ring structure corresponding to a fluorine-containing cyclic group and a modifying layer containing an organic compound such as a basic group-containing metal complex. Such an ionomer of the related art has low binder performance and/or surface-active performance because it may cause aggregation of particles of the electrode catalyst and/or generation of cracks in the electrode catalyst layer when used as a binder of the electrode catalyst. In contrast, in the ionomer of the present embodiment, a nitrogen-containing cyclic organic compound or a polymer thereof or a cation thereof contained in the modifying layer interacts with an acidic functional group, a fluorine-containing cyclic group, and/or a polymer constituting the ionomer. Thus, in the ionomer of the present embodiment, the crystallinity of the polymer and/or the adsorption property of the polymer to the electrode catalyst can be optimized, and the oxygen transport property can be improved. In addition, in the ionomer of the present embodiment, the agglomeration of the particles of the electrode catalyst when used as a binder of the electrode catalyst can be substantially suppressed. Therefore, by having the catalyst layer containing the components exemplified above, the ionomer of the present embodiment can exhibit high binder performance and surface-active performance in addition to high oxygen transportability.

In each embodiment of the present disclosure, the nitrogen-containing cyclic organic compound or a polymer thereof or a cation thereof means a compound containing a nitrogen atom in a ring member and/or a ring-bonding group of a monocyclic or polycyclic cyclic organic compound or a polymer thereof or a cation thereof. The nitrogen equivalent weight of the nitrogen-containing cyclic organic compound is usually in the range of 20 g to 270 g/equivalents, in particular in the range of 20 g to 70 g/equivalents. The nitrogen equivalent weight of the nitrogen-containing cyclic organic compound is defined by the following formula: nitrogen equivalent weight (g/equivalent)=molecular weight (g/mol) of the nitrogen-containing organic compound/material weight (molN/mol) of nitrogen atoms contained in one molecule of the nitrogen-containing organic compound. In the case of a polymer of a nitrogen-containing cyclic organic compound, the nitrogen equivalent of the monomer contained in the polymer may be within the range exemplified above.

The number of nitrogen atoms in the nitrogen-containing cyclic organic compound is not particularly limited. For example, the nitrogen atom number of the nitrogen-containing cyclic organic compound is preferably 3 or more, and more preferably in the range of 3 to 6 as the total number of basic nitrogen atoms. The nitrogen atom number of the nitrogen-containing cyclic organic compound is preferably 3 or less, more preferably 0 to 3, as the total number of nitrogen atoms of the ring-bonding group.

Examples of the nitrogen-containing cyclic organic compound include pyridine, pyrrole, thiazole, isothiazole, oxazole, isoxazole, imidazole, imidazoline, pyrazole, 1,3,5-triazine, pyrimidine, pyritazine, pyrazine, indole, quinoline, isoquinoline, purine, benzimidazole, benzoxazole, benzthiazole, tetrazole, tetrazine, triazole, carbazole, acridine, quinoxaline and quinazoline. The nitrogen-containing cyclic organic compound exemplified above may have, as the ring-bonding group, one or more substituted or unsubstituted amines or amino (e.g., primary amines, secondary amines, tertiary amines or quaternary ammonium cations), hydroxyl, halogen (e.g., fluorine, chlorine, bromine or iodine), nitrile, amide, imide, thiol, sulfonyl, carboxyl, phosphonyl, ketone, aldehyde, ester, substituted or unsubstituted alkyl, substituted or unsubstituted alkenyl, substituted or unsubstituted alkynyl, substituted or unsubstituted cycloalkyl, substituted or unsubstituted cycloalkenyl, substituted or unsubstituted cycloalkynyl, substituted or unsubstituted heterocycloalkyl, or substituted or unsubstituted heterocycloalkyl alkyl, substituted or unsubstituted aryl, substituted or unsubstituted arylalkyl, substituted or unsubstituted heteroaryl, Substituted or unsubstituted heteroarylalkyl, substituted or unsubstituted alkoxy, substituted or unsubstituted cycloalkoxy, substituted or unsubstituted heterocycloalkoxy, substituted or unsubstituted aryloxy, substituted or unsubstituted arylalkyloxy, substituted or unsubstituted arylalkenyloxy, substituted or unsubstituted hetero-aryloxy, or substituted or unsubstituted acyloxy. The number of carbon atoms of the group exemplified above is usually in the range of 1 to 10 in the case of a chain, and is usually in the range of 3 to 16 in the case of a ring. When the above-exemplified groups are substituted, the substituent is preferably one or more groups selected from the above-exemplified groups.

The nitrogen-containing cyclic organic compound, a polymer thereof, or a cation thereof is preferably melamine (1,3,5-triazine-2,4,6-triamine), ammeline, ammelide, cyanuric acid or triazine (1,2,3-triazine, 1,2,4-triazine or 1,3,5-triazine), a derivative thereof, a polymer thereof, or a cation thereof, more preferably melamine or a derivative thereof (nitrogen equivalent 21 g/equivalent), ammeline, ammelide, 1,3,5-triazine or a derivative thereof (nitrogen equivalent 27 g/equivalent), thiocyanuric acid or a derivative thereof (nitrogen equivalent 59 g/equivalent), cyanuric acid or a derivative thereof (nitrogen equivalent 34 g/equivalent), oleylamine or a derivative thereof (nitrogen equivalent 267 g/equivalent), tetradecylamine or a derivative thereof (nitrogen equivalent 213 g/equivalent), 2,4,6-tris [bis (methoxymethyl) amino]-1,3,5-triazine (nitrogen equivalent 65 g/equivalent), 6-(dibutylamino)-1,3,5-triazine-2,4-dithiol (nitrogen equivalent 68 g/equivalent), 2,4-diamino-6-butylamino-1,3,5-triazine (nitrogen equivalent 30 g/equivalent), 2,4,6-tris (pentafluoroethyl)-1,3,5-triazine (nitrogen equivalent 145 g/equivalent), a polymer using these as monomers, a copolymer such as a melamine formaldehyde copolymer, such as methylated poly (melamine-co-formaldehyde) (nitrogen equivalent 20 g to 40 g/equivalent) or isobutylated poly (melamine-co-formaldehyde) (Nitrogen equivalent 20 g to 40 g/equivalent), or a cation thereof, and further preferably 1,3,5-triazine, ammelide, melamine, or a cation thereof.

Examples of the polymer of the nitrogen-containing cyclic organic compound include a monomer or a copolymer containing the above-exemplified nitrogen-containing cyclic organic compound as at least one monomer. In the case of the polymer of the nitrogen-containing cyclic organic compound, the degree of polymerization is preferably in the range of 1 to 10000, and more preferably in the range of 10 to 10000.

The content of the nitrogen-containing cyclic organic compound or the polymer thereof or the cations thereof is preferably in the range of 1 mol % to 120 mol %, and more preferably in the range of 10 mol % to 60 mol %, based on the total amount of the acidic functional groups. The content of the nitrogen-containing cyclic organic compound or the polymer thereof or the cation thereof is preferably 10% by mass or less, and more preferably 0.1% to 10% by mass with respect to the total mass of the ionomer of the present embodiment. When the content of the nitrogen-containing cyclic organic compound or the polymer thereof or the cation thereof is less than the lower limit, the desired effect may not be exhibited. When the content of the nitrogen-containing cyclic organic compound or the polymer thereof or the cations thereof exceeds the above upper limit value, the binder performance and/or the surface-active performance may be deteriorated. Therefore, by having a catalyst layer containing a nitrogen-containing cyclic organic compound or a polymer thereof or a cation thereof in the contents exemplified above, the ionomer of the present embodiment can exhibit high binder performance and surface-active performance.

The composition and content of the nitrogen-containing cyclic organic compound or a polymer thereof or a cation thereof contained in the modifying layer can be determined, for example, by the following analysis. Dissolution and extraction of the modifying layers contained in the ionomer of this embodiment, and analysis of the components contained in the extract by elemental analysis, various chromatographic methods, ultraviolet-visible spectroscopy (UV-Vis), infrared spectroscopy (IR), or nuclear magnetic resonance (NMR).

By having the features described above, the ionomer of the present embodiment can exhibit high binder performance and surfactant performance.

The binder performance and the surfactant performance of the ionomer of the present embodiment can be evaluated, for example, by the following measurement. Preparing a catalytic ink of an electrochemical oxygen reduction catalyst using the ionomer as a binder, and measuring particle size profiles (e.g., D50 and D90, and variations thereof) of the electrode catalyst particles in the catalytic ink. Alternatively, an MEA using the electrochemical oxygen-reducing catalyst as a cathode can be prepared using the prepared catalyst ink and evaluated by confirming the occurrence of cracking in the electrode catalyst layers of the cathode.

The oxygen transportability of the ionomer of the present embodiment can be evaluated, for example, by the following method. An electrochemical oxygen reduction catalyst is prepared using the ionomer as a binder. An MEA is prepared using the electrochemical oxygen-reduction catalyst as a cathode. The oxygen-diffusion resistivity in the electrode catalyst layer of MEA is measured.

The proton conductivity of the ionomer of the present embodiment can be evaluated, for example, by the following method. An electrochemical oxygen reduction catalyst is prepared using the ionomer as a binder. An MEA is prepared using the electrochemical oxygen-reduction catalyst as a cathode. The current-voltage properties of MEA at low humidification conditions (e.g., 30% RH) and high humidification conditions (e.g., 80% RH) are measured (e.g., the proton-transport resistance in the electrode catalyst layer or the cell voltage at a given current density).

### 2: Electrochemical Oxygen Reduction Catalyst

Another aspect of the present disclosure relates to an electrochemical oxygen reduction catalyst. The electrochemical oxygen reduction catalyst of the present embodiment has a catalyst metal having oxygen reduction activity and a binder containing the ionomer of one embodiment of the present disclosure.

In the electrochemical oxygen reduction catalyst of the present embodiment, the catalyst metal may be any metal having oxygen reduction activity (oxygen reduction catalytic ability). Examples of the catalyst metal include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, prascodymium, neodymium, samarium, gadolinium, and yttrium. The catalyst metal may include the above-exemplified metals alone or as two or more alloys. The catalyst metal may be an oxide, a nitride, a sulfide, a phosphide, or the like of the metals exemplified above.

The catalyst metal is preferably platinum, a platinum alloy or a composite comprising platinum. In the case of the composite containing platinum alloy and platinum, examples of the metal other than platinum include metals such as ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium. The composite containing a platinum alloy and platinum may contain two or more kinds of the metals exemplified above. By containing the catalyst metal exemplified above, the electrochemical oxygen reduction catalyst of the present embodiment can exhibit high oxygen transport property and/or proton conductivity.

The content of catalyst metal is usually in the range from 1% to 70% by weight, for example in the range from 48% to 50% by weight, in particular in the range from 18% to 48% by weight, based on the total weight of the electrochemical oxygen reduction catalyst according to the embodiment. In the case where the catalyst metal is a composite containing a platinum alloy and platinum, the content of the metal other than platinum is usually in the range of 0.11 atomic % to 60 atomic % with respect to the total mass of the catalyst metal. The electrochemical oxygen reduction catalyst of the present embodiment can exhibit high oxygen transport property and/or proton conductivity by containing the catalyst metal in the above-mentioned range.

The particle size of the catalyst-metal is usually in the range from 1 nm to 100 nm.

In the electrochemical oxygen reduction catalyst of the present embodiment, the composition and the content of the catalyst metal can be determined by, for example, the following method. The catalyst metal contained in the electrochemical oxygen reduction catalyst of this embodiment is dissolved and extracted. The metallic elements contained in the extract are analyzed by thermogravimetric analysis (IG) or radio frequency inductively coupled plasma-emission spectroscopy (ICP).

In the electrochemical oxygen reduction catalyst of the present embodiment, the particle diameter of the catalyst metal can be determined by, for example, measuring the crystallite diameter by an X-ray diffraction method and calculating the average crystallite diameter. Alternatively, the particle size of the catalyst metal may be determined by measuring the particle size of 100 to 1000 catalyst metal particles by an electron microscope and calculating the average value (average particle size) thereof.

The electrochemical oxygen reduction catalyst of this embodiment usually has a support on which the catalyst metal is supported. Carriers can include, for example, conductive carbon and oxides, and mixtures of one or more thereof. The carbon is preferably carbon black (such as acetylene black, Ketjen black, and furnace black), activated carbon, black lead, glassy carbon, graphite, graphene, carbon fiber, carbon nanotube, carbon nitride, sulfurized carbon, phosphated carbon, channel black, roller black, disk black, oil furnace black, gas furnace black, lamp black, thermal black, or Vulcan carbon, or a mixture of one or more thereof. The oxide is preferably titanium oxide, niobium oxide, tin oxide, tungsten oxide or molybdenum oxide, or a mixture of one or more thereof. The support is preferably carbon, and more preferably carbon black.

The carrier may be either a primary particle or a secondary particle. The particle size of the primary particles of the carrier is usually between 5 nm and 5000 nm.

In the electrochemical oxygen reduction catalyst of the present embodiment, the composition, the content, and the particle size of the support can be determined, for example, by means similar to the determination of the composition, the content, and the particle size of the catalyst metal described above.

By providing the features described above, the electrochemical oxygen reduction catalyst of the present embodiment can exhibit high oxygen transport property and/or proton conductivity without substantially causing agglomeration of particles and/or generation of cracks in the electrode catalyst layer.

The oxygen transport property and the proton conductivity of the electrochemical oxygen reduction catalyst of the present embodiment can be evaluated by the same method as the evaluation of the oxygen transport property and the proton conductivity of the ionomer of one embodiment of the present disclosure.

### 3: Ionomer Applications

Another aspect of the present disclosure relates to a fuel cell. The fuel cell of the present embodiment includes at least an electrode catalyst layer of the cathode, an electrode catalyst layer of the anode, and an electrolyte membrane disposed between the electrode catalyst layer of the cathode and the electrode catalyst layer of the anode. The electrode catalyst layer of the cathode includes an electrochemical oxygen reduction catalyst and an ionomer of one embodiment of the present disclosure.

Yet another aspect of the present disclosure relates to a water electrolysis system. The water electrolysis system of the present embodiment includes at least an electrode catalyst layer of the cathode, an electrode catalyst layer of the anode, an electrolyte membrane disposed between the electrode catalyst layer of the cathode and the electrode catalyst layer of the anode, and a water supply unit. The electrode catalyst layer of the anode includes an electrochemical oxygen reduction catalyst and an ionomer of one embodiment of the present disclosure.

Yet another aspect of the present disclosure relates to a metal-air battery. The metal-air battery of the present embodiment includes at least an electrode catalyst layer of a cathode, a metal layer of an anode, and an electrolyte membrane disposed between the electrode catalyst layer of the cathode and the metal layer of the anode. The electrode catalyst layer of the cathode includes an electrochemical oxygen reduction catalyst and an ionomer of one embodiment of the present disclosure.

The fuel cell, the water electrolysis system, and the metal-air cell of the present embodiment include the ionomer of the present disclosure in an electrode catalyst layer of a cathode or an anode. Accordingly, it is possible to exhibit high oxygen transport property and/or proton conductivity without substantially causing occurrence of cracks or the like in the electrode catalyst layer. Therefore, the fuel cell of the present embodiment can be applied to, for example, a fuel cell for an automobile, a ship, or a railway vehicle.

### 4: Method for Producing Ionomer

Another aspect of the present disclosure relates to a method for producing an ionomer of one aspect of the present disclosure. The method of this aspect comprises a modification step. The method of this embodiment may optionally include a preparation step, an electrode catalyst preparation step, and an electrode catalyst layer preparation step.

### 4-1: Preparation Process

This step includes providing an ionomer material having an acidic functional group and a fluorine-containing cyclic group (hereinafter also simply referred to as “ionomer material”) and a modifier. The process also typically includes providing a catalyst metal, a support, and a binder. Further, the step may optionally comprise providing additional materials such as solvents and substrates.

The ionomer material, the catalyst metal, the support, and the binder prepared in this step may be any material having the characteristics described above. For example, the catalyst metal prepared in this step may be supported on the support described above.

The modifier provided in this step includes at least a cation of a nitrogen-containing cyclic organic compound or a polymer thereof. The cation of the nitrogen-containing cyclic organic compound or the polymer thereof contained in the modifier may be any material having the characteristics described above.

In this step, each material may be prepared by preparing a material having predetermined characteristics by itself, or may be prepared by purchasing a commercially available product or the like. For example, the ionomer material may be prepared according to a publication (for example, Japanese Unexamined Patent Application Publication No. 2013-216811 (JP 2013-216811 A)).

### 4-2: Modification Process

The step includes mixing an ionomer material having an acidic functional group and a fluorine-containing cyclic group with a modifying agent to modify the acidic functional group.

In this step, an ionomer material having an acidic functional group and a fluorine-containing cyclic group and a modifier are usually mixed together with a solvent. The solvent is not particularly limited, and any liquid can be used. Solvents can include, for example, water and alcohols, and mixtures of one or more thereof. Examples of the alcohol include methanol, ethanol, 1-propanol, 2-propanol, 2-methyl-2-propanol (tert-butyl alcohol), diacetone alcohol, ethylene glycol, and propylene glycol.

In this step, the mixing means of the material is not particularly limited. Mixing means can include, for example, ultrasonic homogenizer, jet mill, beads mill, ball mill, high share and fill mix. Specific conditions (e.g., stirring speed, stirring time, and rotation speed) of the mixing means exemplified above are not particularly limited, and can be appropriately set within an arbitrary range.

The process may optionally include a vacuum defoaming process in which the resulting mixture is defoamed under vacuum conditions. In this case, the specific conditions of the vacuum defoaming treatment (for example, pressure, treatment time, and the like) are not particularly limited, and can be appropriately set within an arbitrary range. The vacuum defoaming treatment may be performed a plurality of times.

In this step, by removing the solvent from the resulting mixture, an electrochemical oxygen reduction catalyst comprising the ionomer of one embodiment of the present disclosure can be obtained. The removal of the solvent is not particularly limited, and may be performed by any means such as heat drying or filtration.

By carrying out this step, the acidic functional group of the ionomer material can be modified with a modifying layer containing a nitrogen-containing cyclic organic compound or a polymer thereof or a cation thereof.

### 4-3: Electrode Catalyst Preparation Process

The step includes mixing a catalyst metal and a binder to prepare an electrode catalyst. The binder used in this step includes an ionomer having a modifying layer prepared in the above step.

In this step, the catalyst metal and the binder are usually mixed together with a solvent. As the solvent, the same solvent as the solvent used in the modification step described above can be used. As the mixing means of the material, the same mixing means as the mixing means used in the modification step described above can be used.

The process may optionally include a vacuum defoaming process in which the resulting mixture is defoamed under vacuum conditions. In this case, the specific conditions of the vacuum defoaming treatment (for example, pressure, treatment time, and the like) are not particularly limited, and can be appropriately set within an arbitrary range. The vacuum defoaming treatment may be performed a plurality of times.

In this step, by removing the solvent from the resulting mixture, an electrochemical oxygen reduction catalyst comprising the ionomer of one embodiment of the present disclosure can be obtained. The removal of the solvent is not particularly limited, and may be performed by any means such as heat drying or filtration.

Alternatively, when carrying out the electrode catalyst layer preparation step described below, the mixture obtained in this step can be used in the electrode catalyst layer preparation step as a catalyst ink containing an electrochemical oxygen reduction catalyst containing the ionomer of one embodiment of the present disclosure. In this case, the mixture obtained in this step may be used as it is, or may be used by further adding the solvent exemplified above.

By carrying out this step, an electrochemical oxygen reduction catalyst comprising the ionomer of one embodiment of the present disclosure can be obtained.

### 4-4: Electrode Catalyst Layer Manufacturing Process

The step includes applying a catalyst ink comprising the electrochemical oxygen reduction catalyst obtained in the electrode catalyst preparation step to the surface of the substrate.

The base material used in this step is not particularly limited, and any material such as polytetrafluoroethylene (PTFE), an electrolyte membrane having an ion-exchange group, carbon fibers, and metallic fibers can be used.

In this step, the means for applying the catalyst ink is not particularly limited. Examples of the coating means include a die coating method, a spin coating method, a screen printing method, a doctor blade method, a squeegee method, a spray coating method and an applicator method. The specific conditions of the coating means exemplified above are not particularly limited, and can be appropriately set within an arbitrary range.

In this step, the solvent is usually removed from the catalyst ink after coating. The removal of the solvent is not particularly limited, and may be performed by any means such as heating and drying. Specific conditions of removal of the solvent (for example, temperature, pressure, treatment time, and the like) are not particularly limited, and can be appropriately set within an arbitrary range.

By carrying out this step, an electrochemical oxygen reduction catalyst containing the ionomer of one embodiment of the present disclosure can be obtained in a form (electrode catalyst layer) disposed on the surface of a substrate. In this case, the film thickness of the electrode catalyst layer is usually in the range of 5 μm to 30 μm. The content of the catalyst metal in the electrode catalyst layer is usually 0.1 mg/cm² to 0.6 mg/cm² as the mass with respect to the total area of the electrode catalyst layer.

As described above, the ionomer of one embodiment of the present disclosure and the electrochemical oxygen reduction catalyst containing the ionomer can be produced by carrying out the method of the present embodiment.

As described in detail herein, the ionomer of one embodiment of the present disclosure and the electrochemical oxygen reduction catalyst comprising the ionomer have high oxygen transport properties, binder performance and/or surfactant performance. In addition, the production method of one embodiment of the present disclosure can efficiently provide the ionomer of one embodiment of the present disclosure having high oxygen transport property, binder performance, and/or surfactant performance, and an electrochemical oxygen reduction catalyst containing the ionomer. An electrochemical oxygen reduction catalyst comprising an ionomer of one aspect of the disclosure is applied, for example, to a cathode of a fuel cell. Accordingly, it is possible to provide a fuel cell having a high oxygen transport property and/or a high proton conductivity without substantially causing occurrence of cracks or the like in the electrode catalyst layer. Such a fuel cell can be suitably used, for example, as a fuel cell for an automobile, a marine vessel, or a railway vehicle.

Hereinafter, the present disclosure will be described in more detail with reference to Examples. However, the technical scope of the present disclosure is not limited to these examples.

### I: Production of Ionomers

### I-1: Preparation of Ionomers

A perfluorocarbon sulfonate polymer (EW: 900) was prepared as an ionomer material in accordance with the publication (JP 2013-216811 A). The perfluorocarbon sulfonic acid polymer has 1,3-dioxolane-4,5-diyl substituted with one or more perfluoroalkyls as a fluorine-containing cyclic group. A predetermined nitrogen-containing cyclic organic compound or a polymer thereof, or a modifier containing a cation thereof was prepared so as to be 10 mol % of the total amount (mol) of the acidic functional groups of the ionomer material having the acidic functional group. The ionomer material, the modifier, and the solvent (water) were charged to the container in a predetermined amount. Using an ultrasonic homogenizer and a stirrer, these materials were stirred and mixed for 15 minutes or more to prepare an ionomer having a modifying layer (modification step).

As Comparative Example 1, an acyclic ionomer without a modifying layer was prepared. The acyclic ionomer having no modifying layer was prepared in the same manner as described above except that an ionomer material having no fluorine-containing cyclic group (perfluorocarbon sulfonate polymer, Nafion, Chemours, Inc., EW: 1100) was used and no modifier was added. As Comparative Examples 2 and 3, a fluorine-containing cyclic ionomer having no modifying layer was prepared by the same procedure as described above except that an ionomer material having a fluorine-containing cyclic group prepared by the same procedure as described above was used and no modifier was added.

### II: Production of Electrochemical Oxygen Reduction Catalysts

### II-1: Preparation of Catalyst Ink

The support (acetylene black) was charged with a predetermined quantity of a catalyst metal particle-supported support (primary particle diameter: 10 nm to 100 nm) on which platinum particles (particle diameter: 3 nm to 4 nm) were supported, a binder containing the ionomer prepared in the above-described manner, and a solvent (water). A stirrer (homogenizer and fill mix) was used to mix and stir these materials to prepare a catalyst ink comprising an electrochemical oxygen reduction catalyst (modification step). The content of platinum particles in the electrochemical oxygen reduction catalyst was from 48% to 50% by weight, based on the total weight of the catalyst.

### II-2: Preparation of Catalyst Layer

Using a homogenizer and a fill mix, the prepared catalytic ink was applied onto a substrate (a plate made of polytetrafluoroethylene (PTFE)). The catalyst ink after the coating was heated, and the solvent was dried and removed (catalyst ink coating step). The resulting catalytic layers had a film thickness of 5 μm to 30 μm and a platinum loading of 0.1 mg/cm² to 0.6 mg/cm².

### II-3: Preparation of Membrane Electrode Assembly

Each catalyst layer prepared in the above procedure was prepared as a cathode catalyst layer. A perfluorocarbon sulfonate polymer (NafionNR211, EW: 1100 made of Chemours) was prepared as an electrolyte membrane. A platinum-supported carbon catalyst (TEC10E50E manufactured by Tanaka Precious Metal Industry Co., Ltd.) was prepared as an anode catalyst layer. The electrolyte membrane was sandwiched between the cathode catalyst layer and the anode catalyst layer. The cathode catalyst layer, the electrolyte membrane, and the anode catalyst layer were thermocompression bonded under heated (130°° C.) and pressurized (3 MPa) conditions. A gas-diffusion layer (GDL22BB manufactured by SGL) made of carbon fibers was disposed on the outer side of the cathode catalyst layer and the anode catalyst layer, and a membrane electrode assembly (MEA) (electrode portion: 1 cm×1 cm) was prepared.

### III: Performance Evaluation of Electrochemical Oxygen Reduction Catalysts

### III-1: Electrochemical Performance Evaluation of Membrane Electrode Assembly

MEA prepared in the above-described manner was used as a single cell to measure current-voltage properties under low humidification conditions (30% RH) and high humidification conditions (80% RH). The measurement conditions are as follows. Sweep rate: 20 mA/s (anode sweep), cell temperature: 80°° C., pressure: 150 kPa_abs, cathode gas species: air, cathode gas flow rate: 2.0 L/min.

### III-2: Evaluation Results

Tables 1 and 2 show the results of evaluating the composition of the ionomer prepared in the above procedure and MEA having the electrochemical oxygen-reduction catalyst containing the ionomer. In the table, the melamine-formaldehyde copolymer shown as a component of the modifying layer means methylated poly (melamine-co-formaldehyde) (nitrogen-equivalent weight 20 g to 40 g/equivalent weight). In the tables, the amounts of changes in D50 and D90 of the electrode catalyst particles in the catalytic ink represent the amounts of changes with respect to D50 and D90 of Comparative Example 2 in Examples 1 to 4. In the tables, the amount of change in D50 and D90 of the electrode catalyst particles in the catalytic ink means the amount of change with respect to D50 and D90 of Comparative Example 3 in Example 5.

TABLE 1

| Item | Example 1 | Example 2 | Example 3 | Example 4 | Example 5 |
|---|---|---|---|---|---|
| Modifying layer | 1,3,5-triazine | Ammeline | Ammeline | Melamine | Melamine |
| Basic nitrogen atom | 3 | 4 | 5 | 6 | 6 |
| number of the | | | | | |
| nitrogen-containing | | | | | |
| cyclic organic | | | | | |
| compound | | | | | |
| Number of nitrogen | 0 | 1 | 2 | 3 | 3 |
| atoms in the ring- | | | | | |
| bonding group of the | | | | | |
| nitrogen-containing | | | | | |
| cyclic organic | | | | | |
| compound | | | | | |
| Amount of nitrogen- | 10 | 10 | 10 | 10 | 10 |
| containing cyclic | | | | | |
| organic compound | | | | | |
| (mol %) relative to | | | | | |
| the total amount of | | | | | |
| acidic functional | | | | | |
| groups of the | | | | | |
| ionomer | | | | | |
| Object of the | Ionomer | Ionomer | Ionomer | Ionomer | Ionomer |
| modifying layer | | | | | |
| Ionomer | Fluorine- | Fluorine- | Fluorine- | Fluorine- | Fluorine- |
| | containing | containing | containing | containing | containing |
| | cyclic | cyclic | cyclic | cyclic | cyclic |
| | ionomers | ionomers | ionomers | ionomers | ionomers |
| Presence of cyclic | Y | Y | Y | Y | Y |
| groups in the ionomer | | | | | |
| Amount of cyclic | 2.5 | 2.5 | 2.5 | 2.5 | 4.0 |
| group (mol %) | | | | | |
| relative to the total | | | | | |
| amount of acidic | | | | | |
| functional groups of | | | | | |
| the ionomer | | | | | |
| D50 of electrode | 4.52 | 4.33 | 4.16 | 3.70 | 3.11 |
| catalyst particles in | | | | | |
| catalyst ink | | | | | |
| Change in D50 of | −0.25 | −0.44 | −0.61 | −1.07 | −4.57 |
| electrode catalyst | | | | | |
| particles in catalyst | | | | | |
| ink | | | | | |
| D90 of electrode | 6.45 | 6.17 | 5.72 | 5.05 | 4.34 |
| catalyst particles in | | | | | |
| catalyst ink | | | | | |
| Change in D90 of | −0.27 | −0.55 | −1 | −1.67 | −7.00 |
| electrode catalyst | | | | | |
| particles in catalyst | | | | | |
| ink | | | | | |
| Cracks in the catalyst | None | None | None | None | None |
| layer | | | | | |
| Evaluation | Very good | Very good | Very good | Good | Good |

TABLE 2

| | Comparative | Comparative | Comparative |
|---|---|---|---|
| Item | Example 1 | Example 2 | Example 3 |
| Modifying layer | — | — | — |
| Basic nitrogen | — | — | — |
| atom number of the | | | |
| nitrogen-containing | | | |
| cyclic organic | | | |
| compound | | | |
| Number of nitrogen | — | — | — |
| atoms in the ring- | | | |
| bonding group | | | |
| of the nitrogen- | | | |
| containing cyclic | | | |
| organic compound | | | |
| Amount of nitrogen- | 0 | 0 | 0 |
| containing cyclic | | | |
| organic compound | | | |
| (mol %) relative to | | | |
| the total amount | | | |
| of acidic functional | | | |
| groups of the ionomer | | | |
| Ionomer | Acyclic | Fluorine- | Fluorine- |
| | ionomer | containing | containing |
| | | cyclic | cyclic |
| | | ionomers | ionomers |
| Presence of cyclic | None | Y | Y |
| groups in the | | | |
| ionomer | | | |
| Amount of cyclic | 0 | 2.5 | 4.0 |
| group (mol %) | | | |
| relative to the total | | | |
| amount of acidic | | | |
| functional groups | | | |
| of the ionomer | | | |
| D50 of electrode | 2.91 | 4.77 | 7.68 |
| catalyst particles in | | | |
| catalyst ink | | | |
| D90 of electrode | 4.86 | 6.72 | 11.34 |
| catalyst particles in | | | |
| catalyst ink | | | |
| Cracks in the | None | Y | Y |
| catalyst layer | | | |
| Evaluation | Bad | Bad | Bad |

As shown in Tables 1 and 2, in the electrochemical oxygen reduction catalyst containing the ionomers of Examples 1 to 5, the particle size of the electrode catalyst particles in the catalyst ink was smaller than that of the electrochemical oxygen reduction catalyst containing the ionomers of Comparative Examples 2 and 3. The ionomers of Comparative Examples 2 and 3 have a fluorine-containing cyclic group but no modifying layer. In addition, in MEA having the electrochemical oxygen-reducing catalyst containing the ionomers of Comparative Examples 2 and 3, cracking was observed in the electrode catalyst layers of the cathode. On the other hand, in MEA having the electrochemical oxygen-reducing catalyst containing the ionomers of Examples 1 to 5, no cracking or the like was observed in the electrode catalyst layers of the cathodes. From these results, it was clarified that the ionomer of the present disclosure has high binder performance and surfactant performance capable of suppressing the aggregation of the electrode catalyst particles and the occurrence of cracks in the electrode catalyst layer.

The present disclosure is not limited to the above-described embodiments, and includes various modifications. For example, the above-described embodiments have been described in detail for the purpose of illustrating the present disclosure in an easy-to-understand manner, and are not necessarily limited to those having all the described configurations. Further, it is possible to add, delete, and/or replace a part of the configuration of each embodiment with another configuration.

What is claimed is:

1. An ionomer comprising:
an acidic functional group;
a fluorine-containing cyclic group; and
a modifying layer that modifies the acidic functional group, wherein
the fluorine-containing cyclic group contains 3 to 16 ring member atoms, and
the modifying layer contains a nitrogen-containing cyclic organic compound, a polymer of the nitrogen-containing cyclic organic compound, or a cation of the nitrogen-containing cyclic organic compound or the polymer.

2. The ionomer according to claim 1, wherein the fluorine-containing cyclic group is 1,3-dioxolane-4,5-diyl substituted with one or more perfluoroalkyls.

3. The ionomer according to claim 1, wherein the modifying layer contains 1,3,5-triazine, ammelide, or melamine.

4. A fuel cell comprising at least:
an electrode catalyst layer of a cathode containing an electrochemical oxygen reduction catalyst and the ionomer according to claim 1;
an electrode catalyst layer of an anode; and
an electrolyte membrane disposed between the electrode catalyst layer of the cathode and the electrode catalyst layer of the anode.

5. A method of producing the ionomer according to claim 1, the method comprising:
mixing an ionomer material having an acidic functional group and a fluorine-containing cyclic group with a modifying agent containing a nitrogen-containing cyclic organic compound, a polymer of the nitrogen-containing cyclic organic compound, or a cation of the nitrogen-containing cyclic organic compound or the polymer, and modifying the acidic functional group.
